(19) United States
(12) Patent Application Publication
(10) Pub. No.: US 2005/0113985 A1
(43) Pub. Date: May 26, 2005

(54) Obstacle avoidance system for rotary wing aircraft

(75) Inventor: Randall A. Greene, White Plains, NY (US)

Correspondence Address: DENNISON, SCHULTZ & DOUGHERTY;612 Crystal Square 4, 1745 Jefferson Davis Highway, Arlington, VA, 22202-3417, US

(73) Assignee: SAFE FLIGHT INSTRUMENT CORPORATION

(21) Appl. No.: 10/721,463

(22) Filed: Nov. 26, 2003

(51) Int. Cl. G06F 7/00

(52) U.S. Cl. 701/9

(57) ABSTRACT

An airborne obstacle detector for a helicopter includes a visual display, a GPS receiver and an altimeter for indicating the position and course of an aircraft. A computer provides moving map data indicative of a topography of an area which surround the position of the aircraft. The computer determines a first hazard zone within a first preselected distance from the aircraft and generates a first color display of a first hazard zone based on the moving map data. The computer also detects a more danger zone within a second preselected distance from the aircraft which is less then the first preselected distance and generates a second color display of the more dangerous zone. A detector then senses a physical obstacle which is within a third preselected distance from the aircraft which is less than the first preselected distance from the aircraft and sends a signal to an alarm. The alarm then produces a series of audible clicks which increase in frequency and/or volume as the aircraft approaches the obstacle. A mute subsystem, a visual alarm in place of a muted audio signal and a mute override are also disclosed.

### FIELD OF THE INVENTION

This invention relates to an obstacle avoidance system for rotary wing aircraft such as a helicopter and more particularly to an improved airborne obstacle avoidance system which provides visual and audible warnings to a pilot to take corrective action to avoid a hazardous condition.

### BACKGROUND FOR THE INVENTION

Low flying aircraft, especially helicopters, run the risk of colliding with electrical power lines and other physical obstructions. Power lines are not easy to see while other physical obstructions may be missed when a pilot focuses his/her attention on a difficult maneuver.

Several approaches have been taken to aid a pilot in avoiding electrical power lines and other physical obstructions. For example, my earlier U.S. Pat. No. 6,002,348 of Greene et al. discloses a pilot's aid for detecting power lines. As disclosed therein, an airborne power line detector and warning system includes a low frequency radio and antenna for detecting an AC signal of about 50 to 60 hertz. The system also includes a sub-system for producing a unique audio signal such as a series of clicks for warning a pilot that he is flying close to one or more power lines. In addition, the system includes a mute feature for muting the audio signal and replacing it with a visual signal. The system also includes a gain sensor for replacing the audio signal at any time that the helicopter reduces its distance to a power line. A second system or backup system is also disclosed. That system includes a GPS receiver and GIS data base to position a helicopter with respect to a power line grid and sound an alarm when the helicopter approaches a power line.

Another approach for avoiding stationary obstacles is disclosed in a U.S. Pat. No. 6,076,042 of Tognazzini entitled “Altitude Sparse Aircraft Display” which discloses a system and method and apparatus for avoiding aircraft collisions with stationary obstacles. In such systems, the aircraft is provided with a simplified uncluttered on board display of all objects which are in or proximate to the projected path of the aircraft at its particular altitude plus or minus a predetermined increment such as 100 feet constituting a hazard zone. The display presents the hazards in the zone in geographical relationship to the position and path of the aircraft. In addition to the obstacles and the hazard zone, the display may also present topographical features of the underlying terrain. This information is in the form of a muted presentation of a topographical moving map. Then, as the aircraft approaches a hazard in the hazard zone, the presentation of the obstacles or hazards within the zone is enhanced to draw increasing attention to the pilot. When the aircraft arrives at the periphery of the predetermined hazard avoidance maneuver area where corrective action is imperative, the display undergoes a dramatic change. A further feature of the system may give an audible warning in addition to audible directions as to the action to be taken to avoid collision.

A further approach to avoiding physical obstacles is disclosed in the U.S. Pat. No. 6,583,733 of Ishihara et al. which relates to an enhanced ground proximity warning system. That system utilizes navigational information from a global positioning system and/or flight management system and/or commercial navigational system and also includes a terrain/obstacle data base and a corrected barometric altitude signal. The latitude and longitude of the current aircraft position are applied to an airport and terrain search algorithm which provides a terrain warning signal based on the position and flight path vector of the aircraft. Oral warnings are provided by a voice generator and speaker while visual warnings are provided by a moving map display.

It is now believed that there may be a relatively large commercial market for an airborne obstacle detection and warning system in accordance with the present invention. There should be a relatively large demand because such systems provide an enhanced warning to a pilot which facilitates taking corrective action and which are highly reliable. Such systems are also relatively inexpensive to manufacture and install, are of minimal weight and size, easy to install and service, durable and at the same time provide a clear warning to a pilot that the aircraft is flying in a vicinity of a physical obstacle. In addition, it is believed that the airborne obstacle detector and warning system disclosed herein will overcome to a large degree the short comings of the prior art devices as will become apparent from a reading of a detailed description of the invention.

### BRIEF SUMMARY OF THE INVENTION

In essence, the present invention contemplates an improved airborne obstacle detector and warning system for alerting a pilot of a rotary wing aircraft of the proximity of a physical obstacle. The system includes a visual display and means such as a GPS receiver and altimeter for indicating the altitude of the aircraft, the course of the aircraft and the position of the aircraft. The system also includes a computer for providing a moving map display on the visual display to thereby show the topography of an area that surrounds the position of the aircraft. Means including the computer for determining a first hazard zone based on the course and altitude of the aircraft are also provided. In a preferred embodiment of the invention, the means for determining the first hazard zone generates a first color display of the first hazard zone on the visual display based on the moving map data. The system also includes means including the computer system for detecting a second or more dangerous hazard zone based on the course and altitude of the aircraft and for generating a second color display of the more dangerous zone based on the moving map data to warn a pilot of the more dangerous zone. Also, in a preferred embodiment of the invention, the system includes means for detecting a physical obstacle within one of the zones and within a preselected distance from the aircraft and means for producing a series of clicks similar to those produced by a geiger counter when the aircraft is within a preselected distance from the obstacle and for increasing the frequency of the series of clicks as the aircraft approaches the physical obstacle.

The invention will now be described in connection with the accompanying drawings wherein like numbers have been used to indicate like parts.

### DESCRIPTION OF THE DRAWINGS

FIG. 1 is a schematic perspective view of a helicopter in the proximity of power lines wherein the helicopter includes a prior art warning system;

FIG. 2 is a diagramatic view of a prior art warning system;

FIG. 3 is a diagramatic illustration of a prior art system for avoiding aircraft collisions with stationary obstacles;

FIG. 4 is a depiction of a display of a surrounding terrain of a type used in the present invention;

FIG. 5 is a diagramatic illustration of a system in accordance with the present invention; and

FIG. 6 is a flow chart illustrating the operation and method of the invention.

### DETAILED DESCRIPTION OF THE PREFERRED EMBODIMENTS OF THE INVENTION

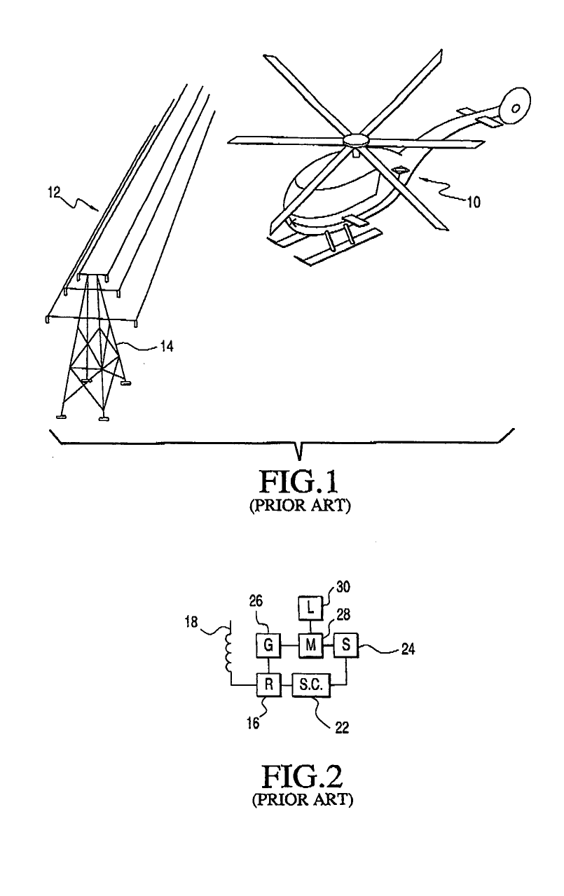

FIGS. 1 and 2 illustrate a prior art power line detection system as described in my aforementioned U.S. Pat. No. 6,002,348 which is incorporated herein in its entirety by reference. As illustrated in FIGS. 1 and 2, a helicopter 10 is shown in proximity to a plurality of power lines 12 which are suspended from a tower 14 in a conventional manner. As disclosed in the patent, a low frequency radio 16 is tuned to a frequency of a power line, about 60 hertz and is adapted to respond to a predetermined output level. This output level is produced when an aircraft flies within the proximity of one or more power lines and is a function of the amount of power being transmitted over the lines and the distance of the aircraft from the power lines. The output of the receiver is then an indication of distance.

The low frequency radio 16 is operatively connected to an antenna 18 in a conventional manner. Also, the receiver 16 is designed to select a signal of about 50 to 60 hertz from the signals which are available at the antenna. This is accomplished by tuning the receiver to the desired frequency by means of a conventional tunning circuit.

The antenna 18 which is connected to the low frequency radio 16 may have a variety of different shapes and lengths as will be well understood by persons of ordinary skill in the art. However, a simple whip antenna and a VLF radio (0.2-11 KH_{z}) have been used. A VLF radio receiver and antenna as described is available from S. P. Mc Greevy Productions of Loan Pine, Calif. 93545-0928. As disclosed, the radio receiver feeds a signal to a signal converter 22 (labeled S.C. in FIG. 2) which produces a series of clicks similar to those produced by a geiger counter. As the strength of the signal increases, the signal converter increases the frequency of the clicking sound to alert the pilot that the aircraft is approaching the power line.

The signal converter 22 may, for example, comprise a rectifier or an AGC circuit, which converts the radio signal into a linear DC signal and into a series of pulses. As the radio signal increases the DC signal, this operates a DC frequency converter which outputs square waves to drive an audio signal to thereby produce a series of clicks as will be well understood by a person of ordinary skill in the art. It is also contemplated that the series of clicks may be produced in a number of other ways, as for example, by a computer chip and sound board with appropriate programming.

The signal converter 22 produces a loud clicking sound by means of a suitable speaker 24 or headphones to thereby warn a pilot of the proximity of one or more power lines. The pilot is then alerted to visually identify the obstruction and avoid flying too close to the power line.

In helicopters of the type used for medical emergencies, it is frequently necessary to fly the aircraft, land and take off in an area that is near one or more power lines. It is also frequently necessary to wait on the ground, in the proximity of an accident, while one or more individuals are extricated from the accident and loaded onto the aircraft. Therefore, means such as a mute button 28 is provided for muting the sound from the warning system. This means for muting the sound 28 may also be connected to a light 30 for producing a visual signal such as a continuous or pulsating red light when the audible signal is muted. For example, a two position manual switch may be provided in order to switch from an audible signal to a visual warning.

From a practical stand point, accidents can occur when a helicopter or other aircraft leaves the scene of an accident. For example, a pilot may become preoccupied with transporting an injured individual and forget about the proximity of power lines. The pilot might even overlook a flashing or continuous red light, particularly if a plurality of emergency vehicles with flashing lights are at the scene of the accident. For this reason the system includes a gain sensor circuit 26 for detecting an increase in signal strength (due to a reduction in the distance between the aircraft and the power line) and for overriding the mute feature in the event of any such gain. By overriding the mute feature, a pilot is once again reminded of the danger of a nearby power line when the distance between the aircraft and power line decreases.

The gain sensor circuit 26 may, for example, includes a simple level detector and comparative circuit. For example, when the mute button is pressed, it establishes a reference level. It establishes a reference level based on the strength of the D.C. voltage. Then, when the signal exceeds the reference signal, as for example, when the aircraft comes closer to a power line, it operates a switch that reconnects the audio signal. The circuit for the above may take a number of conventional forms, but would be tuned for the specific design of a warning system as will be well understood by a person of ordinary skill in the art.

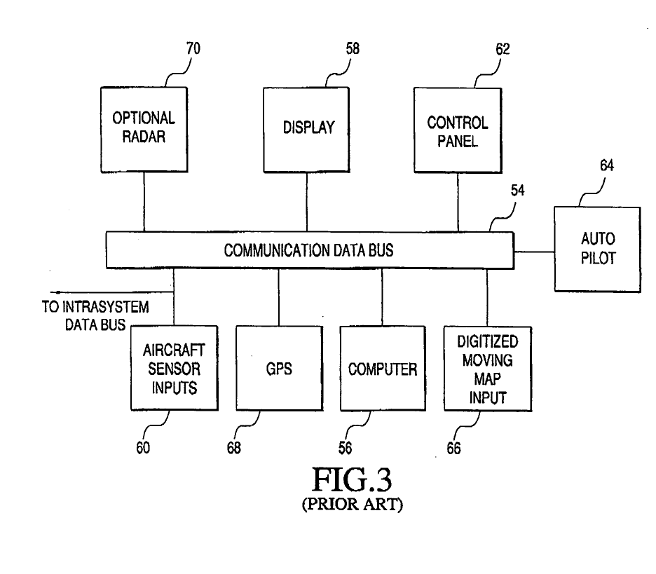

FIG. 3 illustrates an altitude sparce aircraft display of a type disclosed in the aforementioned U.S. Pat. No. 6,076,042 of Tognazzini which is also incorporated herein in its entirety by reference. As described therein that figure shows the intrasystem communication data bus diagrammatically at 54. The hazard management computer 56 integrates the hazard management functions as described. A hazard management display 58 is strategically placed in the aircraft cockpit within the normal field of vision of the pilot. The aircraft sensor inputs are indicated at 60 and would normally provide aircraft velocity, direction, rate of climb/descent, altitude and related functions. A connection to the intrasystem communication data bus may be provided for obtaining these and additional aircraft parameter inputs. These may include such characteristics as the minimum turn radius of the aircraft at various speeds, the rate of climb capability at the existing altitude, speed and engine functionality, the practical rate of deceleration under existing conditions, and the like parameter. It will be obvious that these parameters are condition dependent and in the case of commercial aircraft are also dependent upon passenger comfort and panic reaction threshold. A system control panel is provided at 62 while the autopilot is indicated at 64. A digitized moving map input 66 provides the topographical data for the terrain being transversed.

It is essential to the functioning of the system that the position of the aircraft be accurately known at all times. To this end the system entails reliance upon the Global Positioning System. This is a space-based triangulation system using satellites and computers to measure positions anywhere on earth. A GPS receiver providing an output to the communication buses 54 is shown at 68. Radar 70 may optionally be used in conjunction with the aircraft position determination system.

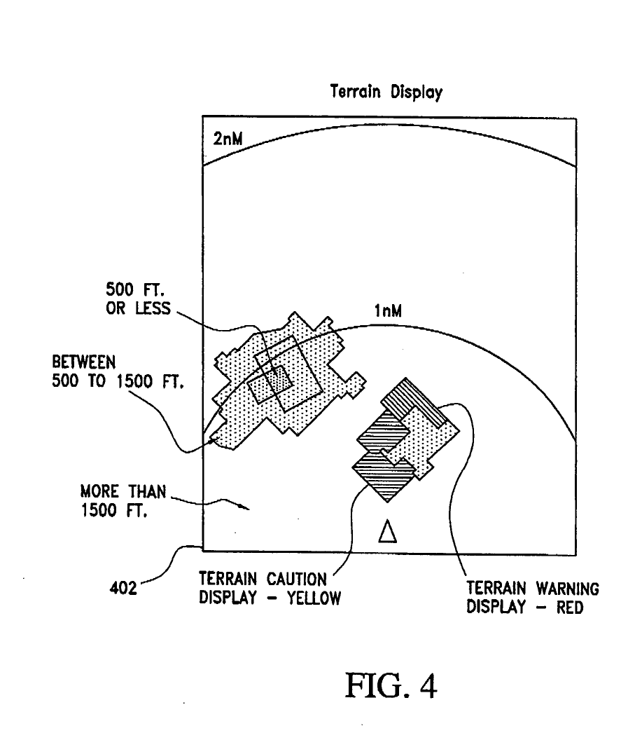

FIG. 4 illustrates how the terrain background information can be shown on a display. The elevation of the terrain relative to the altitude of the aircraft is shown as a series of colored dot patterns whose density varies as a function of the distance between the aircraft and the terrain. The colors are used to distinguish between terrain caution and terrain warning indications. For example, red may be used to represent a terrain warning indication while yellow or amber is used to represent a terrain advisory indication. By using colored shapes for terrain threat indications and dot patterns of variable density for the terrain background information clutter of the display is minimized.

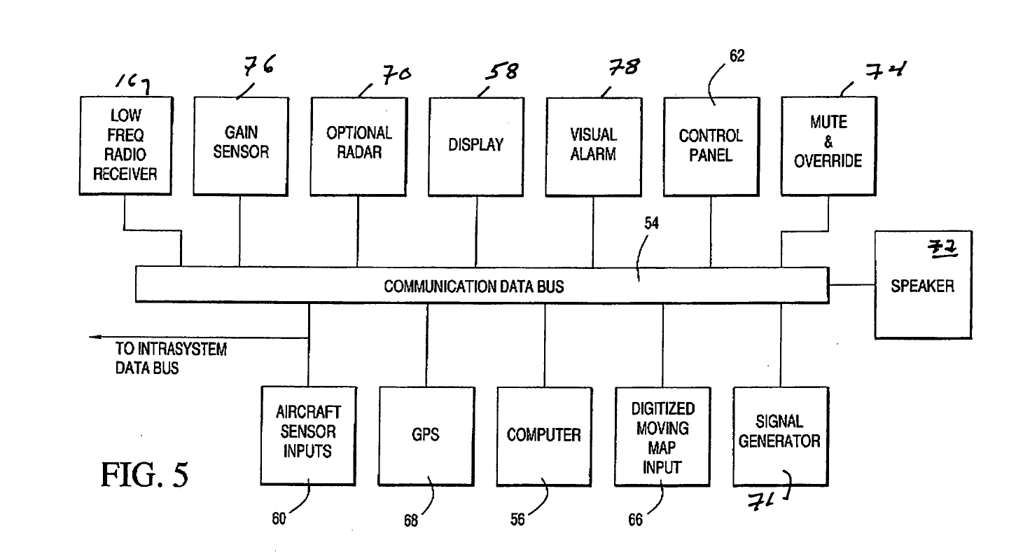

FIG. 5 illustrates a system in accordance with one embodiment of the present invention. As shown therein, the system includes a communication data bus 54 and hazard management computer 56 for integrating the hazard management functions. A hazard management display 58 is strategically placed in the helicopter cockpit in such a position that it will be within the normal field of the pilot's vision. An aircraft sensor input 60 provides aircraft speed, direction, rate of climb or descent, altitude and other relative parameters. A connection to an intrasystem data bus system may be provided for obtaining pertinent aircraft parameter inputs.

In addition, a system control panel 62 is provided and a digitized moving map input 66 provides the topographical data for the terrain being traversed. It is important that the position of the aircraft be known. Therefore, a global positioning system 68 is used. An optional radar 70 may also be used for detecting obstacles.

A preferred embodiment of the invention also includes a low frequency radio receiver 16 and an antenna for detecting a signal of about 50 to 60 hertz and feeds a signal to a signal generator 71 which produces a loud clicking sound or series of clicks by means of a speaker 72. The system also includes means for muting the sound 74 and an override which is triggered by a gain sensor circuit 76 when the aircraft draws near to a power line or other obstacle. The system may also include a visual alarm 78 which may be activated when the audible signal is muted.

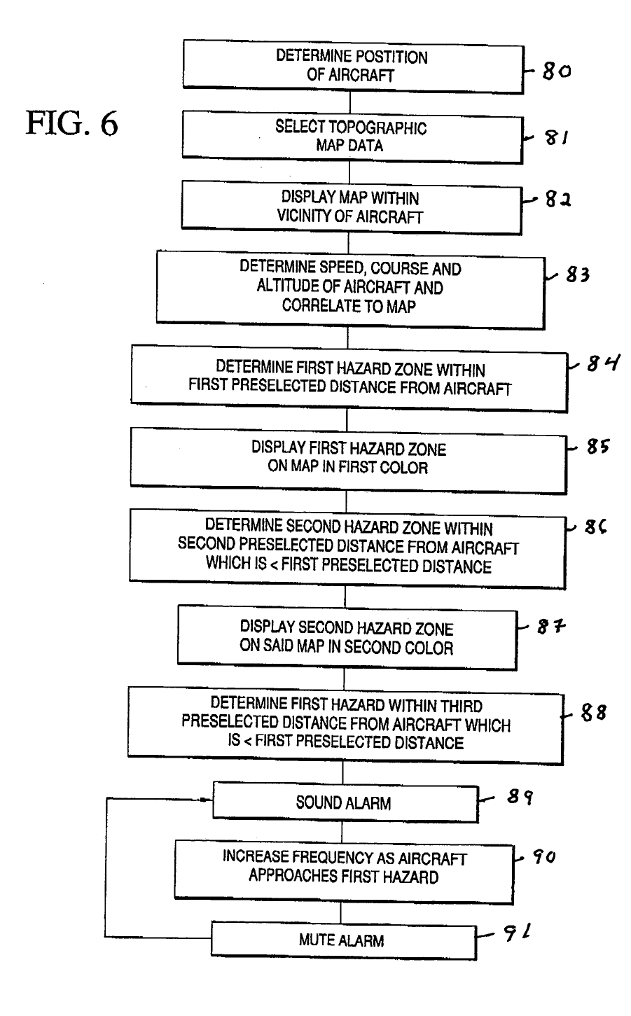

The operation of a system in accordance with the preferred embodiment of the invention is illustrated in FIG. 6. As illustrated therein, the position of an aircraft is determined in step 80 and topographic map data selected in step 81. In step 82, the topographic map within the proximity of the aircraft is displayed. As indicated in 83 the aircraft speed, altitude and course are correlated to the map and a first hazard zone within a first preselected distance from the aircraft is determined in step 84.

The first hazard zone within a first preselected distance from the aircraft is displayed in a first color as for example yellow in step 85 and in step 86 a second hazard zone within a second preselected distance from the aircraft which is less than the first preselected distance is determined and displayed in the second color as for example red in step 87. In step 88, a first hazard or obstacle within a third preselected distance from the aircraft which is less than the first preselected distance is detected. Then in step 89 an audio alarm i.e., a series of clicks is sounded and as the aircraft approaches the obstacle the series of clicks is increased in frequency in step 90. In step 91 the pilot may mute the alarm, however if the aircraft moves towards the obstacle, the alarm will sound and the click will increase in frequency. Further, a visual display may be used such as a flashing red light may be activated when the audio alarm is muted. While the invention has been disclosed in connection with the preferred embodiments, it should be recognized that changes and modifications may be made therein without departing from the scope of the appended claims.

1. An airborne obstacle detector and warning system for alerting a pilot of a rotary wing aircraft of the proximity of a physical obstacle, said system comprising:
a visual display;
means including a GPS receiver for providing data indicative of a position of a aircraft, the altitude of the aircraft and the course of the aircraft;
a computer for providing a moving map data indicative of a topography of an area surrounding the position of the aircraft;
means including said computer for determining a flight hazard zone within a first preselected distance from the aircraft and based on the altitude of the aircraft and for generating a first color display of the first hazard zone based on the moving map data;
means including said computer system for detecting a more dangerous zone within a second preselected distance from the aircraft which is less than the first preselected distance from the aircraft and based on the course and altitude of the aircraft and for generating a second color display of the more dangerous hazardous zone based on the moving map data to warn a pilot of the more dangerous zone;
means for detecting a physical obstacle within a third preselected distance from the aircraft which is less than said first preselected distance from the aircraft; and
means for producing a series of audible clicks when said aircraft is within said third preselected distance from the physical obstacle and for increasing the frequency of the series of clicks as the aircraft approaches the physical obstacle.

2. An airborne obstacle detector and warning system for alerting a pilot of a rotary wing aircraft of the proximity of a physical obstacle according to claim 1 which includes means for increasing the volume of the audible clicks as the aircraft approaces the physical object.

3. An airborne obstacle detector and warning system for alerting a pilot of a rotary wing aircraft of the proximity of a physical obstacle according to claim 2 which includes mute means for muting the series of clicks.

4. An airborne obstacle detector and warning system for alerting a pilot of a rotary wing aircraft of the proximity of a physical obstacle according to claim 3 which includes means for overriding said mute means as the aircraft draws near to the obstacle.

5. An airborne obstacle detector and warning system for alerting a pilot of a rotary wing aircraft of the proximity of a physical obstacle according to claim 4 which includes an additional detection means for detecting a dangerous obstacle within a preselected distance from the aircraft and for generating a signal indicative of a dangerous obstacle and when said aircraft is within a preselected distance from the physical obstacle and for increasing the frequency of the series of clicks as the aircraft approaches the physical obstacle in response to either the first means of detecting a physical obstacle or the additional detection means.

6. An airborne obstacle detector and warning system for alerting a pilot of a rotary wing aircraft of the proximity of a physical obstacle according to claim 5 in which said additional detection means is a low frequency radio receiver and antenna for detecting an AC signal of about 50 to 60 hertz.

7. In an airborne obstacle detector and warning system for alerting a pilot of a rotary wing aircraft of the proximity of a physical obstacle of the type having:
a visual display;
sensors for providing data indicative of an altitude of the aircraft, a course of the aircraft and a position of the aircraft;
a computer for providing a moving map data indicative of topography of an area surrounding the position of the aircraft;
means including said computer for determining a first hazard zone within a first preselected area based on the course and altitude of the aircraft and for generating a display of hazards within the hazard zone based on the moving map data;
means including said computer for detecting a proximate hazard from among the hazards within the hazard zone at a predetermined distance from the aircraft; and
altering means for creating a visual change in appearance of proximate hazards in contrast to other hazards;
the improvement comprising audio means for producing a series of clicks and means for increasing the frequency of the series of clicks as the aircraft approaches the proximate hazard.

8. In an airborne obstacle detector and warning system according to claim 7 wherein the improvement further comprises muting means for muting the audio signal.

9. In an airborne obstacle detector and warning system according to claim 8 wherein the improvement further comprises means for overriding the mute means when the distance between the aircraft and the proximate hazard decreases.

10. An airborne obstacle detector and warning system for alerting a pilot of a rotary wing aircraft of the proximity of a physical obstacle, said system comprising:
a visual display;
sensors for providing data indicative of an altitude of an aircraft, a course of an aircraft and a position of the aircraft;
a computer for providing a moving map data indicative of a topography of an area surrounding the position of the aircraft;
means including said computer for determining a hazard zone based on the course and altitude of the aircraft and for generating a display of hazards within the hazard zone based on the moving map data;
means including said computer system for detecting a proximate hazard from among the hazards within the hazard zone at a predetermined distance from the aircraft;
altering means for creating a visual change in appearance of a proximate hazard in contrast to others of the hazards; and
audio means for producing a series of clicks and for increasing the frequency of the series of clicks as the aircraft approaches the proximate hazard.

11. An airborne obstacle detector and warning system for alerting a pilot of a rotary wing aircraft of the proximity of a physical obstacle, said system comprising:
a visual display;
means including a GPS receiver for providing data indicative of an altitude of an aircraft, a position of the aircraft and a course of the aircraft;
a computer for providing a moving map data indicative of a topography of an area surrounding the position of the aircraft;
means including said computer for determining a first hazard zone within a first preselected distance from the aircraft based on the altitude of the aircraft and for generating a first color display of the first hazard zone based on the moving map data;
means including said computer for detecting a more dangerous zone within a second preselected distance from the aircraft which is less than the first preselected distance and for generating a second color display of the more dangerous hazard zone based on the moving map display to warn a pilot of the more dangerous zone;
means for detecting a physical obstacle within the second of said zones and within a preselected distance from the aircraft which is less than the distance of said first zone; and
means for producing a series of clicks when said aircraft is within a preselected distance from the physical obstacle and for increasing the frequency of the series of clicks as the aircraft approaches the physical obstacle.
